(19) United States
(12) Patent Application Publication
(10) Pub. No.: US 2007/0290109 A1
(43) Pub. Date: Dec. 20, 2007

(54) Storage arrangement

(76) Inventors: Ralph Ahlburg, Gaversheim (DE); Marten Wittorf, Taunus (DE)

Correspondence Address: HARNESS, DICKEY & PIERCE, P.L.C., P.O. BOX 8910, RESTON, VA, 20195, US

(21) Appl. No.: 11/727,977

(22) Filed: Mar. 29, 2007

(30) Foreign Application Priority Data
Mar. 30, 2006 (SE) 0600712-4

(51) Int. Cl. B60N 3/10

(52) U.S. Cl. 248/311.2

(57) ABSTRACT

A storage arrangement for a vehicle is disclosed. In at least one embodiment, the arrangement includes a first wall portion and a second wall portion, which wall portions are at least part of a delimitation of an accessible storage space and define at least part of an entry opening of the storage space. The second wall portion is movable and adjustable relative to the first wall portion between at least a first defined and directly accessible storage position and a second defined and directly accessible storage position, the storage space including a relatively greater storage capacity and a larger entry opening in the second storage position than in the first storage position.

### TECHNICAL FIELD

The present invention relates to a storage arrangement for a vehicle, comprising a first wall portion and a second wall portion, which wall portions are at least part of a delimitation of an accessible storage space and define at least part of an entry opening of said storage space.

### TECHNICAL BACKGROUND

In a modern vehicle, such as a car, storage arrangements, such as pockets, are often demanded. Due to the limited space in the passenger compartment of a vehicle and the space and comfort requirements of the users, these storage pockets are often relatively small and above all, in order to avoid conflicts between the space needed for stepping in and out of the vehicle and/or the passenger-space when riding in the vehicle, these storage pockets often have a limited size. This can, for instance, be the case with storage pockets arranged along the doors of the vehicle and pockets arranged on the seat backs of the front seats. When riding, the passengers in the vehicle often wish to put away in these pockets comparatively large objects, such as road atlases and beverage bottles, but this is not always possible due to the limited size of the pockets. It is also desirable for the storage pockets to be easily accessible by the passengers and the driver during the ride, so that objects can easily be placed in the pocket and objects kept in the pocket can easily be taken out for use.

There is thus a need for storage pockets in a vehicle, which do not limit the space and comfort of the passengers, for example when stepping in and out of the vehicle, while meeting the requirements of sufficient storage volume and entry opening.

These storage pockets also need to be easily accessible during the ride.

There is further a need for such a storage pocket, which is easy to use.

There is further a need for such a storage pocket, which has a simple construction and gives a robust and solid impression.

There is further a need for a storage pocket ensuring safe storage of objects placed in the storage pocket.

### SUMMARY OF THE INVENTION

It is an object of the present invention to provide a storage arrangement that at least partially meets the above-mentioned requirements. This object can be achieved by a storage arrangement according to that stated by way of introduction being given the features defined in claim 1. Other advantageous embodiments of such a storage arrangement are described in the claims dependent on claim 1.

According to one aspect of the present invention, a storage arrangement is provided for a vehicle, comprising a first wall portion and a second wall portion, which wall portions are at least part of a delimitation of an accessible storage space and define at least part of an entry opening of said storage space, said second wall portion being movable and adjustable relative to said first wall portion between at least a first defined and directly accessible storage position and a second defined and directly accessible storage position, said storage space having a greater storage capacity and a larger entry opening in said second storage position than in said first storage position.

A storage arrangement as stated above provides a storage space which is easily accessible when riding in the vehicle and which is easily adjustable between at least a first storage position and at least a second storage position. This results in flexibility in use and allows a user to easily adjust the storage arrangement as he wishes. The storage arrangement can, for instance, be arranged so as to make it possible to store a small beverage bottle, such as a 0.5 litre PET bottle, in a first storage position of the storage space and to store a larger beverage bottle, such as a 1.5 litre PET bottle, in a second storage position of the storage space. In said first storage position, the storage arrangement can suitably be arranged to require less passenger compartment space than in the second storage position. Owing to this, the storage arrangement can in its first storage position allow a passenger more compartment space when riding and/or when stepping in and out of the vehicle, than in the second storage position.

The expression “directly accessible storage position” relates to a storage arrangement in which a user has direct access or admission to the storage space of the storage arrangement. That is to say that the user does not have to move, for instance, a cover or the storage arrangement itself to have access to the storage space, the storage space being open and allowing objects to be put in and/or taken out.

The expression “defined storage position” means that the storage positions, between which the storage arrangement can be moved, are fixed and predefined positions.

It is further advantageous that the storage arrangement, once in a desired storage position, remains in this storage position until the user adjusts the storage arrangement into a new storage position. Owing to this, any undesirable change of the storage arrangement between different storage positions, for instance due to movements of the vehicle, is avoided.

Suitably, said second wall portion is movable and adjustable relative to said first wall portion between three or more defined and directly accessible storage positions, each of said storage positions having a storage capacity and a size of said entry opening differing from said other storage positions.

It is advantageous to be able to alter the storage capacity, the entry opening and optionally also the space required for the storage arrangement between a plurality of defined positions. The user is then able to freely choose, within certain limits, the size of the storage space according to the quantity and size of the object that is to be stored in the storage arrangement. In some embodiments, the space required for the storage arrangement in the passenger compartment of the vehicle can be adjusted in this manner, the storage space of the storage arrangement being, for instance, adjustable to an optional position to obtain the desired space in the passenger compartment of the vehicle.

Preferably, said storage arrangement has a first engagement portion, said second wall portion, or a section connected to said second wall portion, having a second opposite engagement portion, for cooperation with said first engagement portion, to allow said movability and adjustability between said defined and directly accessible storage positions.

The use of cooperating engagement portions is an advantageous way of providing the desired adjustability of the storage space of the storage arrangement. To obtain the desired retaining effect, the second engagement portion should be arranged on said second wall portion or on a section, arm or hinge that is connected to said second wall portion. It is suitable for said first engagement portion to be arranged on said first wall portion, or a section connected to said first wall portion. The first engagement portion can alternatively be arranged on a portion of the storage arrangement that is located in the vicinity of said second wall portion. Suitably, the first engagement portion is fixedly arranged in relation to the first wall portion.

If the storage arrangement has one or more bottom portions and a bottom portion is connected to said second wall portion, said second engagement portion can, for instance, be arranged on this bottom portion connected to the second wall portion. Suitably, the first engagement portion can then be arranged on the first wall portion, or a bottom portion which is connected to said first wall portion.

Both the first and the second engagement portions can be formed in one piece with said first or second wall portion, or a section which is connected to one of said first and second wall portions. The engagement portions can also be formed as separate units which, for instance when assembling the storage arrangement, are arranged at each of said first and second wall portions or a section connected to each one of the wall portions. The first engagement portion can also, if desired, be formed in one piece with a portion of the storage arrangement which is fixedly arranged in relation to said first wall portion. As an alternative, the first engagement portion can be formed as a separate unit, which is arranged at a portion of the storage arrangement that is fixedly arranged in relation to the first wall portion.

Preferably, said first engagement portion and said second engagement portion have hook means which are engageable with each other. These hook means can, for instance, be teeth arranged on said first and second engagement portions. The hook means of the first engagement portion is suitably arranged for engagement with the hook means of the second engagement portion. It has been found advantageous from a constructional point of view to provide the engagement portions with hook means to obtain an engagement between the cooperating engagement portions. It is also possible to arrange the hook means so that, for instance, the first engagement portion has a projection and the second engagement portion has a plurality of recesses into which said projection is insertable. In similar manner, it is also possible to provide the second engagement portion with a projection and the first engagement portion with recesses. With one of these configurations, it is possible to place the first and second wall portions in a selected position relative to each other, the storage arrangement thus being retainable by the hook means in the selected storage position.

Furthermore, at least one of said engagement portions suitably has a plurality of hook means. It can be either the first or the second engagement portion that has a plurality of hook means or some other engagement means. It is advantageous that at least one of the first and second engagement portions has a plurality of hook means or some other engagement means to obtain a storage space which is adjustable between a plurality of selectable storage positions. The other of the first and second engagement portions only has to have one hook means, which can be engaged with one of the plurality of hook means on the opposite engagement portion, to allow adjustability between a plurality of different storage positions. Alternatively, both the first and the second engagement portions can have a plurality of hook means to allow adjustability between a plurality of different storage positions.

Furthermore, for adjustability between a plurality of different storage positions with different sizes of the storage space and the entry opening, at least one of said first and second engagement portions is suitably arranged as an elongate element, which overlaps the corresponding engagement portion. Suitably, the first and second engagement portions are displaceable relative to each other for movability and adjustability between the different storage positions.

Preferably, a relative displacement of said first and second wall portions is counteracted by a motion-retarding action between said first and second engagement portions. The object of said engagement portions is to obtain an effect by which the storage arrangement is retained in the storage position selected by the user. This motion-retarding action can, for instance, be obtained by a snapping engagement between the cooperating hook or engagement means.

Furthermore, said engagement portions are advantageously arranged to be displaced relative to each other by application of a force to at least said second wall portion, said force having a magnitude sufficient to overcome said motion-retarding action. The motion-retarding action between the engagement portions should be of such magnitude that the second wall portion cannot change its position in relation to the first wall portion unintentionally. The motion-retarding action of the engagement should not, however, be greater than allowing a user to easily adjust, for instance by hand, the relative positions of the first and second wall portions, i.e. to move the storage arrangement to a desired storage position.

Suitably, at least one of the engagement portions is flexible relative to the other engagement portion in order to allow said movability and adjustability between said first and second engagement portions. It has been found suitable for one or both engagement portions to be flexible so that a user will be able to move the storage arrangement between different storage positions. This flexibility can, for instance, be obtained by selecting the material of the engagement portions so as to obtain a certain movability. Alternatively, such movability can be obtained, for instance, by a hinge being arranged in connection with at least one of the engagement portions. Yet another way of obtaining such movability is to spring-load at least one of the engagement portions. It has also been found possible to obtain a similar effect by arranging, for instance, the entire second wall portion in a flexible manner. This effect can also be obtained, for instance, by designing the hook or engagement means in such manner that a user can easily move the storage arrangement to a desired storage position, without needing to arrange any of the engagement portions in a flexible or yielding manner. This is possible, for instance, if the hook means are arranged in a flexible manner, for example, by being spring-loaded.

Suitably, the storage space is further delimited by at least a first side wall portion, which extends substantially transversely to said first and second wall portions, at least an end portion of said second wall portion abutting said side wall portion and at least partially overlapping said side wall portion. Suitably, said first engagement portion is located on said first side wall portion and said second engagement portion is located on said end portion of said second wall portion. The storage arrangement suitably has both a first and a second side wall portion which are arranged substantially transversely to the first and second wall portions. Preferably, the first and second side wall portions are arranged in the vicinity of the respective ends or end portions of the second wall portion. The first engagement portion can suitably be connected to either the first or the second side wall portion of the storage arrangement. It is also possible to arrange engagement portions on both the first and second side wall portions.

It is further suitable to provide at least said second wall portion with a hinge means in the vicinity of an end edge of said wall portion, which hinge means allows changing of the distance between said first wall portion and said second wall portion at an end edge of said second wall portion opposite the hinge means. It is then suitable to arrange said engagement portions at the end of the storage arrangement which is opposite the hinge means. Said hinge means can be arranged as a separate hinge part which is arranged in operable connection with said second wall portion. It is also possible to arrange the hinge means as a portion of the storage arrangement, i.e. as an integral hinge portion, for instance formed in one piece with the second wall portion. This can, for instance, be achieved by selecting, treating or arranging the material so that it will be sufficiently flexible for said second wall portion to be movable to a desired position relative to said first wall portion.

Preferably, at least said second wall portion is pivotally arranged about a substantially vertical axis by said hinge means. If it is desirable to arrange said second wall portion at least partially pivotally about a substantially vertical axis, the hinge means is preferably arranged at an end edge of the second wall portion. As an alternative, said storage space is further delimited by a bottom portion, which is substantially opposite said entry opening and which is further connected to at least said second wall portion, at least said second wall portion being pivotally arranged about a substantially horizontal axis by said hinge means. If it is desirable to arrange said second wall portion at least partially pivotally about a substantially horizontal axis, the hinge means is preferably arranged in the vicinity of the transition between the bottom portion and the first or second wall portion. Alternatively, the hinge means can be arranged along the extension of the bottom portion.

The storage arrangement can advantageously be adapted to be arranged along a door or a side wall of a vehicle, the storage arrangement having a longitudinal direction extending substantially in the direction of travel of the vehicle and a width direction extending substantially perpendicularly to said longitudinal direction, said first wall portion adjoining or being part of said door or side wall of said vehicle, and said storage space extending away from said first wall portion into a passenger compartment of said vehicle. The above-described advantages of a user having the possibility of selecting the storage capacity, the size of the entry opening and the space required for the storage arrangement inside the vehicle have been found useful in this connection. It has, for instance, been found suitable to have the possibility of making room for stepping in and out of a vehicle in the described manner.

The storage arrangement can advantageously be arranged so that said second wall portion comprises at least two wall sections, which are movable in relation to each other to provide partial expansion and/or compression of said storage space. It may be desirable not to have to choose one and the same storage position for the entire storage arrangement. It has, for instance, been found suitable to arrange the storage arrangement in such manner that a user can selectively choose a storage position with a great storage capacity for one part of the storage arrangement and a storage position with less storage capacity for another part of the storage arrangement. In this manner, a desired storage capacity can be obtained without arranging the entire storage arrangement in such a position.

Suitably, said storage arrangement is further provided with at least one inner panel, which is arranged in said storage space and extends substantially transversely to said first and second wall portions, thereby dividing said storage space into a plurality of storage sections. By arranging a dividing element inside the storage space of the storage arrangement, it is possible to obtain at least two storage sections. This can, for instance, be advantageous if a user wishes to keep stored objects separate from each other.

If the second wall portion, for instance, has several wall sections, such as two mutually movable wall sections, the panel or the dividing element can suitably be arranged so that the storage space is divided where two wall sections meet. In this manner, it is possible to obtain two separate storage sections which can be moved between independent storage positions in relation to each other.

Suitably, at least one of the wall sections of the second wall portion can be arranged with at least one portion which extends in the width direction of the storage arrangement and is arranged adjacent said inner panel, so that this portion of at least one of the wall sections of the second wall portion at least partially overlaps said inner panel.

Furthermore, said inner panel can suitably be provided with engagement portions, such as hook means or teeth, said portion, extending in the width direction, of at least one of the wall sections of the second wall portion being arranged with corresponding and cooperating hook means or teeth to provide defined selectable relative positions of said wall section and said adjacent inner panel. By this means, a plurality of defined storage positions are possible for at least one of said small storage sections arranged in said storage arrangement.

Finally, at least said second wall portion is suitably arranged as a rigid and self-supporting element. Said first wall portion can suitably also be a rigid and self-supporting portion. A storage arrangement in which at least the second wall portion is a rigid and self-supporting element results in a robust construction, offering good strength and a solid impression.

### BRIEF DESCRIPTION OF THE DRAWINGS

In the following, the present invention will be described with reference to the accompanying exemplifying drawings, in which:

FIG. 1a is a perspective view of a first embodiment of the present invention, the storage arrangement being arranged in a first storage position;

FIG. 1b is a perspective view of a first embodiment of the present invention, the storage arrangement being arranged in a second storage position, in which the storage capacity is greater than in the first storage position;

FIG. 1c is a perspective view of a first embodiment of the present invention, the storage arrangement being arranged in a third storage position, in which the storage capacity is greater than that shown in both FIG. 1a and FIG. 1b;

FIG. 2a is a perspective view of a second embodiment of the present invention, the storage arrangement being arranged in a first storage position;

FIG. 2b is a perspective view of a second embodiment of the present invention, the storage arrangement being arranged in a second storage position;

FIG. 3a is a perspective view of a third embodiment of the present invention, the storage arrangement being arranged in a first storage position; and

FIG. 3b is a perspective view of a third embodiment of the present invention, a section of the storage arrangement in FIG. 3a being arranged in a second storage position.

### DESCRIPTION OF PREFERRED EMBODIMENTS

The invention will now be described by way of non-limiting, currently preferred embodiments of the invention and with reference to the accompanying drawings.

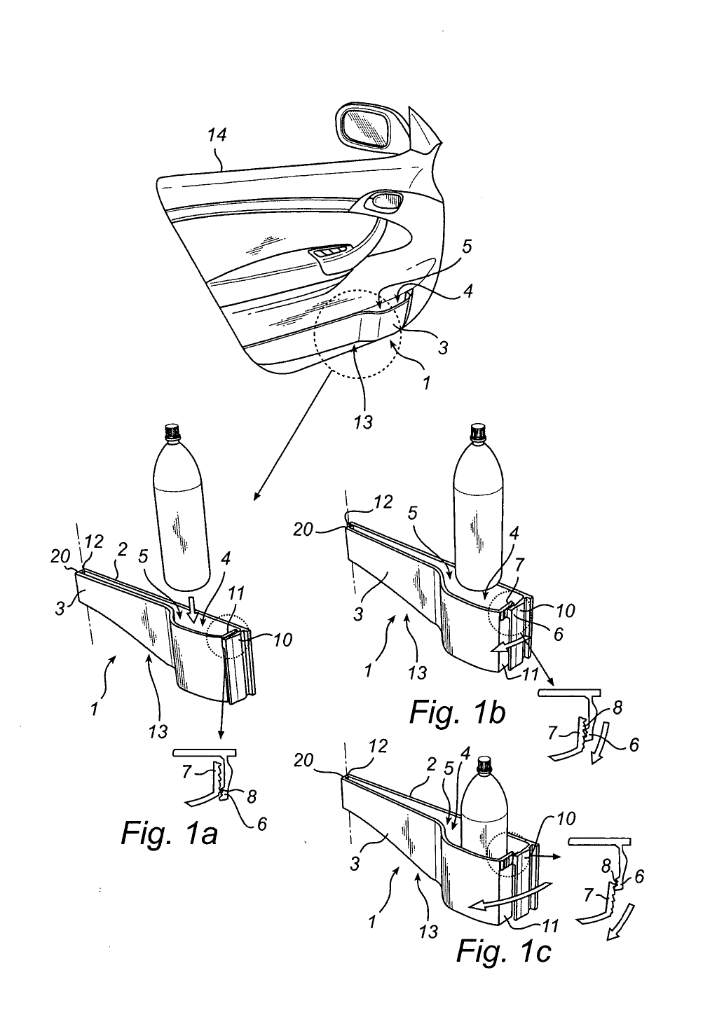

In FIGS. 1a-1c, a first embodiment of the present invention is shown. A storage arrangement 1 is placed along a side door 14 of a vehicle and thus has a length extending in the longitudinal direction of the vehicle. The storage arrangement further has a width extending from the door 14 into the passenger compartment of the vehicle. The storage arrangement 1 comprises a first and a second wall portion 2, 3, which are part of a delimitation of a storage space 4 accessible by an access or entry opening 5. The storage space 4 is also delimited by transverse front and rear side wall portions 10, 20 and a bottom portion 13 (not shown in FIGS. 1a-1c). The rear side wall 20, as seen in the longitudinal direction of the vehicle, is flexibly arranged or comprises a flexibly arranged portion, and this side wall can thus function as a hinge portion 12.

The second wall portion 3 also comprises a front end portion 11, which extends substantially parallel with the front side wall 10 and which overlaps, at least partially, the front side wall 10.

The front side wall 10 is provided with an engagement portion 6, which in this embodiment is a hook means or teeth 8. The end portion 11 of the second wall portion 3 is provided with a corresponding engagement portion 7, which in this case is also a hook means or teeth 8. The hook means 8 are thus engaged with each other during normal use of the storage arrangement.

In this embodiment, the first wall portion 2 is part of the door panel and the second wall portion 3 is formed by a substantially rigid and self-supporting element.

In FIG. 1a, the storage arrangement 1 is placed in a first storage position. In this first storage position, the storage arrangement 1 has its smallest storage capacity, i.e. its smallest storage space 4 and smallest entry opening 5. The storage arrangement 1 is not completely closed, however, and the storage space 4 can be accessed through the entry opening 5.

In FIG. 1b, the storage arrangement has been moved to a second storage position, which has a greater storage capacity than the first storage position. The storage space 4 and the entry opening 5 of the storage space 4 are thus greater in this second position than in the first storage position. Consequently, it is possible to store more or large objects in the storage space 4 in this second storage position than in the first storage position according to FIG. 1a.

The adjustment from the first to the second storage position is performed by applying a force to the second wall portion 3, which force is great enough to overcome a retaining engagement force acting between the engagement portions 6, 7. This force can, for instance, be applied by a user pulling the second wall portion inwardly towards the passenger compartment of the vehicle or by an object, which is larger than the entry opening 5 in the first storage position, being pressed down into the storage pocket 1, thereby providing the required pressure force on the second movable wall portion 3.

The engagement between the engagement portions 6, 7 is thus overcome and the flexible material, which forms the hinge means 12, gives away so that the distance between the first and second wall portions at the front end of the storage arrangement 1 can increase. As is also apparent from a comparison of FIGS. 1a and 1b, the engagement between the teeth 8 on the engagement portions 6, 7 is placed a longer way out when the pocket 1 is in its second storage position.

The engagement portions 6, 7 keep the wall portions 2, 3 in this second storage position until a new force is applied to adjust the storage arrangement 1 to a new adjustable storage position.

In FIG. 1c, the storage pocket 1 is shown in its maximally folded-out position in this embodiment, the storage space 4 thus having its greatest storage capacity and its largest entry opening 5 in this storage position. In FIG. 1c, a beverage bottle is also shown, such as a so-called PET bottle or the like, which is placed and retained in the storage arrangement 1. In this position, the overlap of the front side wall 10 and the end portion 11 of the second wall portion 3 only needs to be large enough for the engagement portions 6, 7 to be engageable with each other.

The adjustment to this position is performed in the same way as the adjustment between the first and the second storage positions, that is to say a force is applied to the second wall portion 3 so that the retaining engagement force between the engagement portions 6, 7 is overcome. The flexible material, the hinge portion 12, is then bent and the distance between the front ends of the wall portions 2, 3 is allowed to increase. This means that the second wall portion 3 is pivoted about a vertical axis formed by the hinge portion.

The engagement portions 6, 7 and/or the front side wall 10 on which the engagement portion 6 is arranged and the end portion 11 can be made of a flexible material so that they can perform a certain movement in the longitudinal direction of the storage space, relative to each other. As an alternative to this flexibility, the hinge portion can be designed so as to allow this movement in the longitudinal direction of the storage arrangement 1. It is also possible to obtain this function, for instance, by providing the front side wall 10 and/or the end portion 11 in the form of an articulated arm which allows a certain movability. This movability in the longitudinal direction of the storage arrangement is suitable so as to allow the engagement portions 6, 7 to be moved between different engagement positions, and thus the storage arrangement 1 between the different storage positions.

The above-mentioned integrated hinge portion 12 can be provided by selecting the material of the second wall portion 3 and/or a side wall portion 20 so that the bending required for moving and placing the storage arrangement 1 in different storage positions can be performed without causing damage to the side wall 20 or the second wall portion 3. It is not necessary for the entire second wall portion 3 or side wall 20 to have these material properties since this is only desirable where the hinge effect is to be obtained.

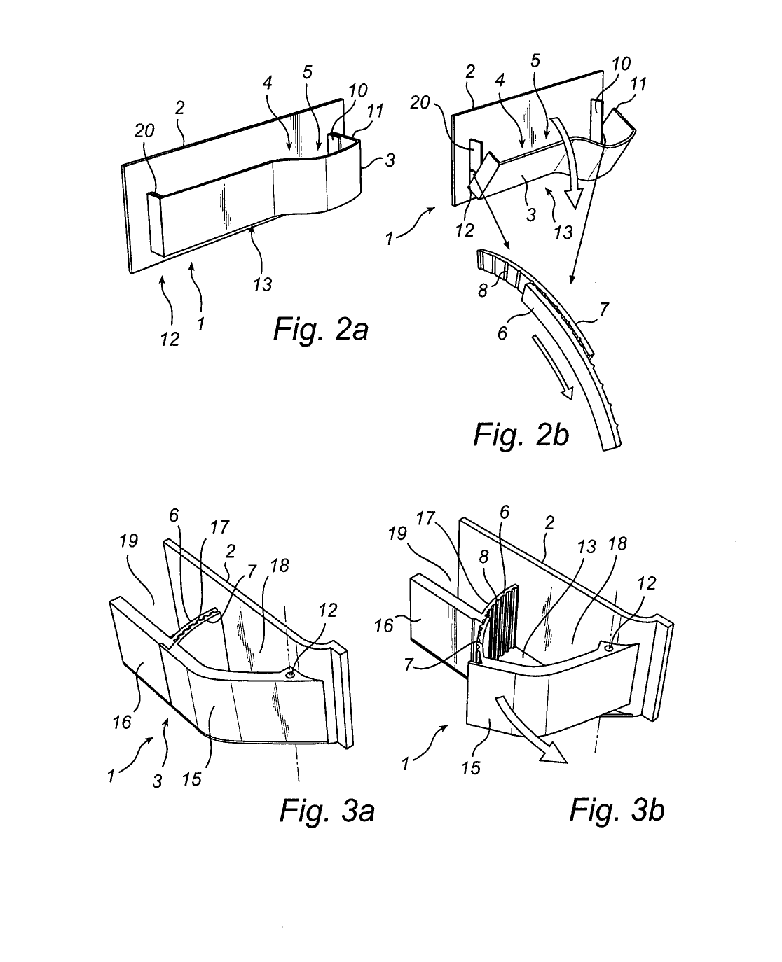

A second embodiment of the invention, which is shown in FIG. 2, comprises parts similar to those of the first embodiment according to FIGS. 1a-1c, these parts thus having the same reference numerals as in FIGS. 1a-1c. The portions substantially corresponding to the above-described embodiment will not be described any further in connection with this second embodiment.

In the second embodiment according to FIGS. 2a and 2b, the storage space is further delimited by a bottom portion 13. A hinge means or hinge portion 12, which can be either a separate unit or be provided by flexible properties of the wall portion material, is arranged in this embodiment in the vicinity of the transition between the second wall portion 3 and the bottom portion 13. The above-mentioned integrated hinge portion 12 can, as in the first embodiment, be provided by selecting the material of the second wall portion 3 and/or a bottom portion 13 so that the bending required for moving and placing the storage arrangement 1 in different storage positions can be performed without causing damage to the bottom portion 13 or the second wall portion 3. It is not necessary for the entire second wall portion 3 or bottom portion 13 to have these material properties since this is only desirable where the hinge effect is to be obtained.

In a first storage position, according to FIG. 2a, the storage arrangement 1 according to this embodiment is positioned in a manner similar to that of the first storage position of the first embodiment according to FIG. 1a. When the storage arrangement 1 has been moved to a second storage position, which is shown in FIG. 2b, the hinge portion 12 is bent in the lower edge of the second wall portion 3, and the distance between the upper portion of the second wall portion 3 and the first wall portion 2 increases. The movable second wall portion is, according to this embodiment, pivoted about a substantially horizontal axis and the distance increases along the entire length of the storage arrangement 1.

Also in this embodiment, the storage arrangement 1 can be placed in a number of different storage positions. The adjustment between the different storage positions is performed in a manner similar to that of the first embodiment, that is to say by a force being applied to the second wall portion 3.

According to this embodiment, the engagement portions 6, 7 have a bent extension, which corresponds to the motion path of the second wall portion 3 relative to the first wall portion 2 when the storage arrangement is moved between different storage positions. According to this embodiment, the storage arrangement 1 is formed with engagement portions 6, 7 at both end edges of the second wall portion, which is shown in FIG. 2b.

FIGS. 3a and 3b show a third embodiment of the present invention. Also in this embodiment, the storage arrangement has a number of parts similar to those described in the previous embodiments, these parts thus having the same reference numerals as in FIGS. 1a-1c and 2a-2b. In this third embodiment, the storage space 4 is divided into two storage sections 18, 19 by a dividing element 17, such as a panel or the like, which extends between the first and second wall portions 2, 3. The dividing element 17 can be fastened to the first wall portion 2, the second wall portion 3 or to both wall portions 2, 3. The second wall portion 3 is arranged as a first and a second wall section 15, 16. At least one of the wall sections 15, 16 is movable relative to the first wall portion 2. An end portion of the first wall section 15 extends parallel with the dividing element 17 and overlaps it. Engagement portions 6, 7 are arranged on the end portion of the wall section 15 and the dividing element 17 so that the wall section 15 can be retained in a desired position in relation to the dividing element 17 and thus the first wall portion 2.

By applying a force to the wall section 15, the wall section 15 can, as in the first and second embodiments described above, be moved from a first storage position, which is shown in FIG. 3a, to a second storage position, which is shown in FIG. 3b. By the engagement portions 6, 7, the wall section 15 can be retained in the second storage position until a new force is applied to the wall section 15 for adjustment to a new storage position (not shown). Also in this embodiment, the pocket can be moved between a plurality of different storage positions.

According to this embodiment, the dividing element 17 and the end edge of the wall section 15 have a slightly bent shape, which allows the engagement portions to engage each other in the relative positions that are possible between the first wall section 15 and the first wall portion 2.

According to this embodiment, the hinge means 12 is a separate hinge component which is arranged at the end of the wall section 15 opposite the engagement portion 7.

It will be understood that this third embodiment can be considered as a storage space 4 having two separate storage sections 18, 19 or as two adjacent storage spaces 4. In the third embodiment described, it is only possible to move the storage space of the storage section 18 between several storage positions, it will however be understood that also the space and the entry opening of the storage section 19 can be arranged to be adjustable. This can be achieved either by making only the storage section 19 movable between different storage positions or by making both storage sections 18 and 19 movable between different storage positions independently of each other.

By adjustment between different storage positions, the storage space according to the above-described embodiments is adapted to hold, for instance, PET bottles, such as PET bottles of sizes 0.5 litre, 1.0 litre or 1.5 litre.

In all the embodiments described above, the engagement portions 6, 7 are arranged so that a force can be applied to the second wall portion 3, towards the first wall portion 2, to move in the second wall portion 3 towards the first wall portion 2, thereby reducing the storage space 4 and the entry opening 5 of the storage arrangement. This movement of the second wall portion 3 is possible provided that no object placed in the storage space limits this movement or that the storage arrangement 1 is not positioned in its most compressed storage position. This design of the storage arrangement 1 can, for instance, be suitable when a user stepping out of the vehicle comes into intended or unintended contact with the storage arrangement. With a reduced risk of being damaged, the storage arrangement 1 can be moved to a storage position in which it requires less space, that is to say a position in which the storage space 4 and the entry opening 5 are reduced, thereby offering more space for the user to step in and out of the vehicle.

It will be understood that even if the invention has been described by exemplifying embodiments, modifications and variations are possible within the scope of the invention. It will also be understood that functions of the different embodiments can be combined with each other to obtain further embodiments.

For example, the storage arrangement does not have to have a rear side wall 20. The first and second wall portions 2, 3 can, for instance, be fastened to each other at their respective rear ends. Nor does the storage arrangement have to have a bottom portion. The respective lower edges of the wall portions 2, 3 can, for instance, be attached to each other. In both these cases, the material of one of the wall portions 2, 3 can function as a hinge portion 12.

Furthermore, the hinge portion does not have to be formed in one piece with one of the wall portions 2, 3 but can be a separate hinge component connected to at least the movable wall portion 3.

Moreover, the bottom portion 13 can be designed in different ways. For instance, it does not have to be a complete bottom portion extending between the two wall portions 2, 3 but it can cover only part of the space therebetween. The bottom portion 13 can also be designed as at least two separate portions which are connected to the first and the second wall portions 2, 3, respectively, the portion connected to the second wall portion 3 following the second wall portion 3 when it is moved away from the first wall portion 2. The different portions of the bottom portion 13 can also overlap each other when the storage arrangement is moved to a compressed storage position. By this design, a bottom portion 13 is obtained which covers the bottom of the storage arrangement 1 irrespective of which storage position the storage arrangement 1 occupies. It is further possible to design the bottom portion 13 as a flexible portion or a portion formed as bellows, which can be adjusted to the current size of the storage space 4. It is also possible to arrange engagement portions 6, 7 on the bottom portion 13 or on portions thereof.

Furthermore, the means for holding the storage arrangement 1 in the desired storage position do not have to be an engagement portion, such as teeth or hooks, but can, for instance, be a plastic hinge or the like, which can fulfil the desired function. The engagement portions can also be, for instance, a device with locking engagement which has to be released before adjustment of the storage arrangement. Such a device can, for instance, be designed such that a cotter or a locking pin is arranged on the first wall portion 2 and holes into which the cotter or the locking pin can be fitted are formed on the second wall portion 3. A user can then, after having removed the cotter or the locking pin from its engagement in a hole, move the second wall portion to a desired storage position and subsequently reinsert the cotter or the locking pin in engagement with another hole to retain the storage arrangement in the desired storage position.

In addition, the storage arrangement 1 according to any one of the above embodiments can be provided with a locking device, which in its locked position prevents movement between the different storage positions. This prevents a user, for instance, from moving the pocket from a first storage position to another storage position by mistake.

Furthermore, the storage arrangement 1 can be equipped with engagement portions at both its front and rear ends, in which case the distance between the wall portions 2,3 can be increased at both ends of the storage arrangement. In such an embodiment, the storage arrangement does not need any hinge means or hinge portions. By arranging engagement portions at both ends of the storage arrangement, it is possible to increase the storage capacity by moving the storage arrangement by translation to a second storage position, that is to say by increasing the distance between the first wall portion 2 and the second wall portion 3. It is also possible to provide an arrangement in which the storage arrangement is moved between different storage positions by a combination of translation and rotation.

It will further be understood that the difference between the defined storage positions can be arranged so as to be adapted for the purpose. If, for instance, the engagement portions are arranged with a small distance between each engaging element, small changes are obtained in each step. Also the number of engaging means, and thus the number of possible storage positions, can be selectively arranged. For example, three or four possible storage positions are convenient if it is desirable to obtain storage capacities of the storage arrangement 1 that are suitable for PET bottles of frequently used sizes.

It will further be understood that, even if the above-mentioned embodiments of the storage arrangement have been described as arranged along a door of a vehicle, it is possible to arrange the storage pocket in other positions in a vehicle. The storage arrangement can, for instance, be arranged on the seat back of a front seat in a vehicle, in such manner that the width of the pocket extends in the same direction as the direction of travel of the vehicle. The storage arrangement can as an alternative, for example, be arranged on a centre console or a dashboard of a vehicle.

Moreover, the first wall portion 2 does not have to be formed in one piece with the door panel 14 but can be made as a separate unit which is mounted, together with the other parts of the storage arrangement 1, in a desired position in the vehicle.

The engagement portions 6, 7 can also be arranged as elongate elements extending in the width direction of the storage arrangement 1 but with a relatively small extension in the vertical direction or as elements extending over a large part of the height of the side wall 10, the end edge of the second wall portion 3 and/or the dividing element 17.

The engagement portions 6, 7 can further be designed as means having a plurality of engaging elements 8 along a distance. It is also possible to provide one of the engagement portions 6,7 with a plurality of engaging elements 8, and the other engagement portion 6, 7 with only one or a few engaging elements 8.

It is also advantageous to arrange the engagement portions 6, 7 according to a form that corresponds to the pattern of relative movement between the first and second wall portions to ensure an engagement between the engagement portions 6, 7, irrespective of which storage position the storage arrangement 1 is placed in.

In addition, it is advantageous to use a storage arrangement of the type described above as a longitudinal storage arrangement along, for instance, a door or a side wall of a vehicle, such as a motor car, a minibus, a bus or the like. The storage arrangement of the above-described type can also be advantageous to use in a vehicle such as a boat or an aeroplane.

Moreover, the storage arrangement 1 does not have to be a separate unit but can be part of a larger storage arrangement.

1. A storage arrangement for a vehicle, comprising:
a first wall portion; and
a second wall portion, the first and second wall portions being at least part of a delimitation of an accessible storage space and defining at least part of an entry opening of said storage space said second wall portion being movable and adjustable relative to said first wall portion between at least a first defined and directly accessible storage position and a second defined and directly accessible storage position, said storage space including a relatively greater storage capacity and a larger entry opening in said second storage position than in said first storage position.

2. A storage arrangement as claimed in claim 1, wherein said second wall portion is movable and adjustable relative to said first wall portion between at least three defined and directly accessible storage positions, each of said storage positions including a storage capacity and a size of said entry opening differing from said other storage positions.

3. A storage arrangement as claimed in claim 1, wherein said storage arrangement includes a first engagement portion, and wherein at least one of said second wall portion, and a section connected to said second wall portion, includes a second opposite engagement portion, for cooperation with said first engagement portion, to allow said movability and adjustability between said defined and directly accessible storage positions.

4. A storage arrangement as claimed in claim 3, wherein said first engagement portion is arranged on at least one of said first wall portion and a section connected to said first wall portion.

5. A storage arrangement as claimed in claim 3, wherein said first engagement portion and said second engagement portion each include at least one hook device, engageable with each other.

6. A storage arrangement as claimed in claim 5, wherein at least one of said engagement portions includes a plurality of hook devices.

7. A storage arrangement as claimed in claim 3, wherein at least one of said first and second engagement portions is arranged as an elongate element, which overlaps the other of said engagement portions, and wherein said first and second engagement portions are displaceable relative to each other for movability and adjustability into said different storage positions.

8. A storage arrangement as claimed in claim 3, wherein a relative displacement of said first and second wall portions is counteracted by a motion-retarding action between said first and second engagement portions.

9. A storage arrangement as claimed in claim 8, wherein said engagement portions are arranged to be displaced relative to each other by application of a force to at least said second wall portion, and wherein said force has a magnitude sufficient to overcome said motion-retarding action.

10. A storage arrangement as claimed in claim 3, wherein at least one of the engagement portions is flexible relative to the other engagement portion to allow said movability and adjustability between said first and second engagement portions.

11. A storage arrangement as claimed in claim 3, wherein the storage space is further delimited by at least a first side wall portion, which extends substantially transversely to said first and second wall portions, and wherein at least an end portion of said second wall portion abuts said side wall portion and at least partially overlaps said side wall portion.

12. A storage arrangement as claimed in claim 11, wherein said first engagement portion is located on said side wall portion and said second engagement portion is located on said end portion of said second wall portion.

13. A storage arrangement as claimed in claim 1, wherein at least said second wall portion is provided with a hinge device in the vicinity of an end edge of said wall portion, which hinge device allows changing of the distance between said first wall portion and said second wall portion at an end edge of said second wall portion opposite the hinge device.

14. A storage arrangement as claimed in claim 13, wherein at least said second wall portion is pivotally arranged about a substantially vertical axis by said hinge device.

15. A storage arrangement as claimed in claim 13, wherein said storage space is further delimited by a bottom portion, which is substantially opposite said entry opening and which is further connected to at least said second wall portion, and wherein at least said second wall portion is pivotally arranged about a substantially horizontal axis by said hinge device.

16. A storage arrangement as claimed in claim 1, which storage arrangement is adapted to be arranged at least one of along a door and a side wall of a vehicle, the storage arrangement having a longitudinal direction extending substantially in the direction of travel of the vehicle and a width direction extending substantially perpendicularly to said longitudinal direction, said first wall portion at least one of adjoining and being part of at least one of said door and side wall of said vehicle, and said storage space extending away from said first wall portion into a passenger compartment of said vehicle.

17. A storage arrangement as claimed in claim 1, wherein said second wall portion includes at least two wall sections, which are movable in relation to each other to provide at least one of partial expansion and partial compression of said storage space.

18. A storage arrangement as claimed in claim 1, wherein said storage arrangement is provided with at least one inner panel, arranged in said storage space and extending substantially transversely to said first and second wall portions, thereby dividing said storage space into a plurality of storage sections.

19. A storage arrangement as claimed in claim 1, wherein at least said second wall portion is arranged as a rigid and self-supporting element.

20. A storage arrangement as claimed in claim 2, wherein said storage arrangement includes a first engagement portion, and wherein at least one of said second wall portion and a section connected to said second wall portion, includes a second opposite engagement portion for cooperation with said first engagement portion, to allow said movability and adjustability between said defined and directly accessible storage positions.

21. A storage arrangement as claimed in claim 4, wherein said first engagement portion and said second engagement portion each include at least one hook device, engageable with each other.

22. A storage arrangement as claimed in claim 14, wherein said storage space is further delimited by a bottom portion, which is substantially opposite said entry opening and which is further connected to at least said second wall portion, and wherein at least said second wall portion is pivotally arranged about a substantially horizontal axis by said hinge device.
